(19) United States
(12) Patent Application Publication
(10) Pub. No.: US 2020/0304336 A1
(43) Pub. Date: Sep. 24, 2020

(54) DEVICE AND METHOD FOR FILTERING SAFETY-RELEVANT INTERVENTIONS, AS WELL AS GATEWAY CONTROL UNIT

(71) Applicant: Robert Bosch GmbH, Stuttgart (DE)

(72) Inventors: Andreas Heyl, Sunnyvale, CA (US); Claus Ritter, Waldbronn (DE); Herbert Reichardt, Aichwald (DE); Stefan Doehren, Remshalden-Grunbach (DE)

(21) Appl. No.: 16/088,896

(22) PCT Filed: Jan. 31, 2017
(86) PCT No.: PCT/EP2017/052012

§ 371 Date: Sep. 27, 2018

(30) Foreign Application Priority Data
Mar. 29, 2016 (DE) 10 2016 205 138.5

(51) Int. Cl. H04L 12/40; H04L 29/08; H04L 29/06

(52) U.S. Cl. CPC H04L 12/40032; H04L 2012/40273; H04L 63/0227; H04L 67/12

(57) ABSTRACT

A device and method for filtering safety-relevant interventions, having a control unit as well as a first communications unit, which is able to exchange data with at least one bus system of a vehicle, and having a second communications unit, which is able to exchange data with an external processing unit. A third communications unit is provided, which differs from the first communications unit and the second communications unit, and the control unit filters the data transfer between the first communications unit and the second communications unit as a function of a parameter received by the third communications unit.

### BACKGROUND INFORMATION

The present invention relates to a device and method for filtering safety-relevant interventions as well as a gateway control unit.

A method for carrying out safety-critical processes in a control unit, and a control unit is described in German Patent Application No. DE 101 48 325 A1. A hardware security module in the control unit receives an input via a first terminal, and the execution of an operation is enabled on the basis of the input.

### SUMMARY

A device, the method as well as the gateway control unit according to the present invention for filtering safety-relevant interventions may have the advantage that due to the receiving of the parameter by the third communications unit, a communications path that differs from the communications paths of the conventional data is created for the safety-critical parameter. For example, a remote activation of software by the vehicle manufacturer may take place because of this further communications path, whereas the loading of the new software into the vehicle is possible only with the aid of a wired connection.

In addition, there is the possibility of providing the different communications units with different security software.

The filtering of the data transfer by the control unit as a function of the parameter before it reaches the bus system reduces the error susceptibility of the vehicle to undesired data that are sent to the vehicle by third parties.

As a consequence of the networking of vehicles, it will be possible in the future that access to driver-assistance systems or their interfaces, and access to diagnostic functions are possible even in the case of vehicles that are already in the hands of users, i.e., vehicles in the field.

With the aid of the present invention, an access by an external processing unit, e.g., a remote access of an application programmed by a developer itself, or the remote retroactive furnishing of firmware updates is able to be carried out more easily under the aspect of security. Even vehicles that are already in the field allow for an expanded retroactive access by the vehicle manufacturer by way of the third communications unit, without the driver of the vehicle becoming aware of it.

A remote access, which theoretically would allow access to all control units, may result in an undesired actuation of control units and actuators that may possibly be safety-relevant for the vehicle. Due to the possibility of filtering the data transfer via a parameter received by the third communications unit, it can be ensured already in the device according to the present invention and in the method according to the present invention or in the gateway control unit according to the present invention that only an access that does not lead to an undesired actuation of control units or actuators in the vehicle will be allowed.

Advantageous embodiments and further developments of the example device according to the present invention and the example method according to the present invention are described herein.

In an advantageous manner, the data transfer may be completely interrupted or data be partially filtered as a function of the received parameter.

This form of filtering allows for a maximum flexibility of different accesses to the bus system and the control units of the vehicle. A second communications unit, which is developed for a wireless data exchange, in particular via W-LAN, wireless mobile radio technology or Bluetooth, is advantageous because this form of a data exchange will be used more frequently in the future, which means, for example, that vehicles need not necessarily be brought to a service facility even in the case of a software update.

It is advantageous if the third communications unit is developed for a wireless data exchange, in particular via W-LAN, wireless mobile radio technology or Bluetooth because this form of a data exchange will be used more and more in the future. Even if the vehicle is already in the field, the vehicle manufacturer may retroactively allow certain access to the bus system of the vehicle.

As an alternative, it is advantageous if the third communications unit is developed for a wired data exchange with an input device which is situated inside the vehicle because the input of the parameter is able to be carried out only via the input device installed in the vehicle. This increases the security because an access to the third communications unit by undesired external attackers is unable to be carried out via the wireless connection.

It is of great advantage if the device is a discrete component that is able to be connected to the OBD jack of the vehicle since this allows for the retroactive fitting of any vehicle with the device for filtering the data transfer.

Preferred exemplary embodiments of the present invention are shown in the figures and are described in greater detail below.

### BRIEF DESCRIPTION OF THE DRAWINGS

FIG. 1 shows a schematic illustration of a device according to the present invention.

FIG. 2 shows a schematic illustration of a device according to the present invention according to a first exemplary embodiment.

FIG. 3 shows a schematic illustration of a device according to the present invention according to a second exemplary embodiment.

FIG. 4 shows a flow diagram of a method according to the present invention.

### DETAILED DESCRIPTION OF EXAMPLE EMBODIMENTS

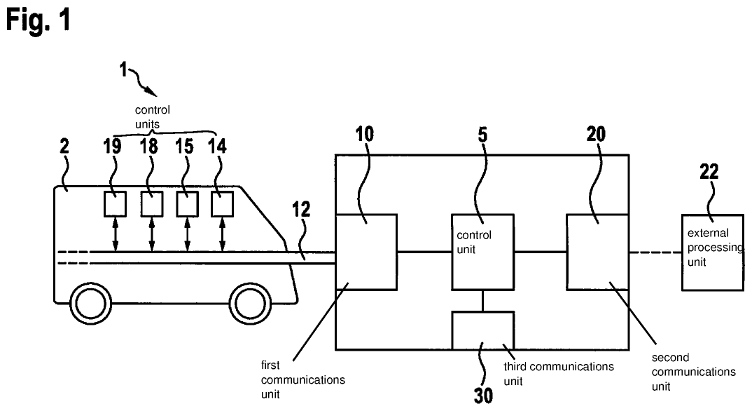

FIG. 1 shows a device 1 for filtering safety-relevant interventions, the device including a control unit 5, a first communications unit 10, a second communications unit 20, and a third communications unit 30. First communications unit 10 is able to exchange data with at least one bus system 12 of a vehicle 2. Second communications unit 20 is able to exchange data with an external processing unit 22. Third communications unit 30 differs from first communications unit 10 and second communications unit 20.

Bus system 12 is situated inside vehicle 2 and is connected to a plurality of control units 14, 15, 18, 19. Control units 14, 15, 18, 19 are able to receive data from bus system 12 and transmit data to bus system 12. Control units 14, 15, 18, 19 may control driver-assistance systems, in which case they perceive the environment and control actuators via vehicle sensors, e.g., the cornering assistant, the parking assistant, or the adaptive cruise system. Via diagnosis protocols or diagnosis functions, which are transmitted via bus system 12 to control units 14, 15, 18, 19, a diagnosis of individual or multiple vehicle components is able to be carried out.

With the aid of the data that are transmitted to bus system 12, control units 14, 15, 18, 19 are able to communicate with one another or with devices that are connected to bus system 12. In simplified form, the data have the following features:

addresses, commands and values.

A specific control unit or a plurality of control units 14, 15, 18, 19 of bus system 12 is addressed by the address. For example, the address may address only a specific control unit 14, a plurality of control units 14, 15, or all control units 14, 15, 18, 19 of a specific bus system 12. The commands include instructions that are transmitted to control unit 14, 15, 18, 19, e.g., the overwriting of functions or the readout of data or diagnostic values. The commands are mostly coupled with values and, for instance, indicate a new value for the steering angle or (distance) values for the parking assistant. However, using diagnosis commands or read commands, it is also possible to read out values from a control unit 14, 15, 18, 19 and to transmit these values via bus system 12 to a diagnosis device.

Control unit 5 filters the data transfer between first communications unit 10 and second communications unit 20 as a function of a parameter received by a third communications unit 30.

Control unit 5 uses the parameter received by third communications unit 30 to verify whether an access to bus system 12 is allowed or whether the user is able to authenticate himself as an authorized person.

The data transfer is completely interrupted or the data are partially filtered as a function of the received parameter. If partial filtering takes place, then filtering of the addresses, of commands, and/or of values may take place as a function of the input parameter. A combination of the addresses, commands and/or values is also possible in such a case.

For example, a particularly highly authorized user may input a special parameter A, which allows an activation of all data, while another user inputs a different parameter B, which merely allows a read access to a few control units.

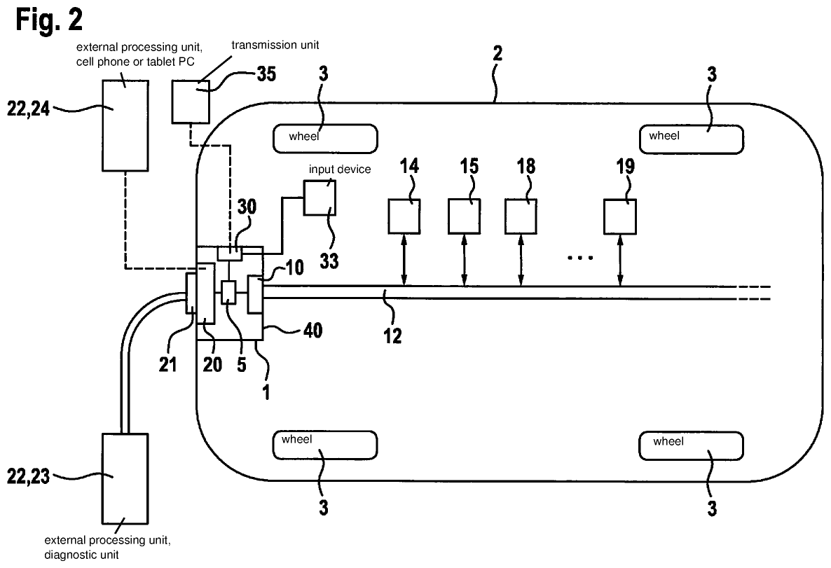

FIG. 2 shows a device 1 for filtering the data transfer according to a second exemplary embodiment, which is integrated into a vehicle 2. Vehicle 2 has wheels 3. Via first communications device 10, device 1 is connected to bus system 12. Bus system 12 has a plurality of control units 14, 15, 18, 19. First communications unit 10 is able to exchange data with the at least one bus system 12.

Device 1 has a second communications unit 20, which is able to exchange data with an external processing unit 22. Second communications unit 20 may be connected to processing unit 22 via a wired connection. For example, this may be a diagnostic device 23 in a service facility, which is connected to an OBD interface 21 of vehicle 2.

However, second communications unit 20 may also be developed for a wireless data exchange. In this case, for example, the data exchange with external processing unit 22, which may be a cell phone 24 or a tablet PC 24, for instance, is carried out via W-LAN, wireless mobile radio technology, or Bluetooth.

Device 1 has a third communications unit 30, which differs from first communications unit 10 or second communications unit 20.

Third communications unit 30 is developed for a wireless data exchange, in particular via W-LAN, wireless mobile radio technology, or Bluetooth. A transmission unit 35, which is likewise developed for a wireless data exchange, is thereby able to transmit a parameter to third communications unit 30. Various encryption methods may be used for this purpose, which, however, are not addressed within the framework of this invention.

In an alternative embodiment, third communications unit 30 may be developed for a wired data exchange with an input device 33. Input device 33 is situated inside vehicle 2 so that a driver is able to input a parameter via input device 33 in order to filter a data transfer.

Control unit 5 filters the data transfer between first communications unit 10 and second communications unit 20 as a function of a parameter which is received by third communications unit 30.

As already described, control unit 5 is able to filter the data transfer with the aid of the parameter in such a way that the data transfer is completely interrupted or the data are partially filtered.

In the exemplary embodiment shown in FIG. 2, device 1 is integrated into gateway control unit 40 so that filtering of the data transfer may already take place in gateway control unit 40.

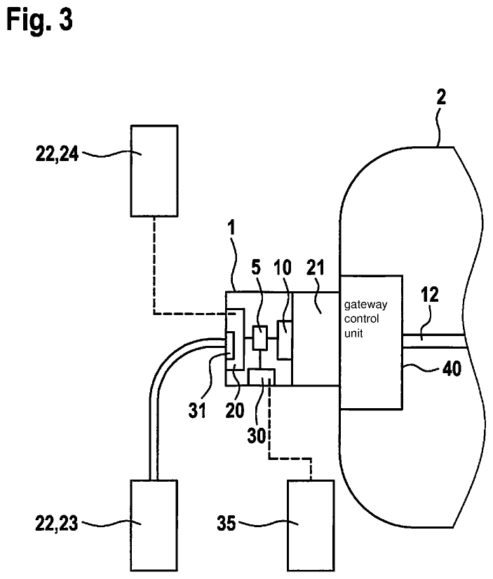

FIG. 3 shows a further exemplary embodiment of the present invention. In this instance, device 1 is not integrated into gateway control unit 40 but developed as a discrete component.

Device 1 is able to be connected to an interface 21, e.g., an OBD jack, of vehicle 2 so that retrofitting of vehicles 2 with device 1 is possible. In all other respects, device 1 shown in FIG. 3 has the same features as in the preceding exemplary embodiments. A communication between communications unit 10 and bus system 12 is carried out via interface 21 and a gateway control unit 40, which is in a data exchange with bus system 12.

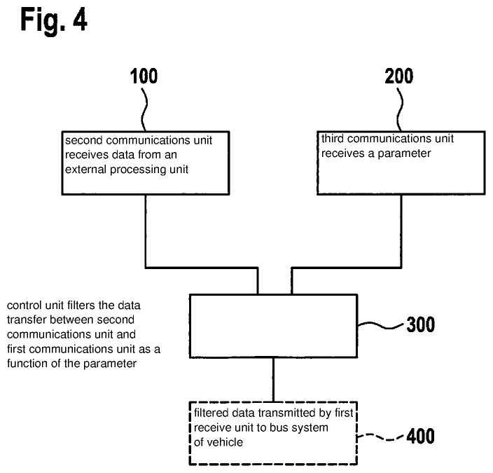

FIG. 4 shows a flow diagram of a method for filtering a data transfer. In method step 100, second communications unit 20 receives data from an external processing unit 22.

In method step 200, third communications unit 30, which differs from first communications unit 10 and from second communications unit 20, receives a parameter.

In method step 300, control unit 5 filters the data transfer between second communications unit 20 and first communications unit 10 as a function of the parameter. The data transfer is completely interrupted as a function of the received parameter or data is able to be partially filtered.

In optional method step 400, the filtered data are transmitted by first receive unit 10 to bus system 12 of the vehicle.

If a data transfer between first communications unit 10 and second communications unit 20 is mentioned within the framework of the present invention, then this involves both data that are carried from second communications unit 20 to first communications unit 10, and data that are carried from first communications unit 10 to second communications unit 20.

1-9. (canceled)

10. A device for filtering safety-relevant interventions, the device comprising:
a control unit;
a first communications unit which is able to exchange data with at least one bus system of a vehicle;
a second communications unit which is able to exchange data with an external processing unit; and
a third communications unit which differs from the first communications unit and the second communications unit;
wherein the control unit filters data transfer between the first communications unit and the second communications unit as a function of a parameter received by the third communications unit.

11. The device as recited in claim 10, wherein, as a function of the received parameter, the data transfer is completely interrupted or data are partially filtered.

12. The device as recited in claim 10, wherein the second communications unit is configured for a wireless data exchange, the wireless data exchange being via one of W-LAN, wireless mobile radio technology, or Bluetooth.

13. The device as recited in claim 10, wherein the third communications unit is configured for a wireless data exchange, the wireless data exchange being via W-LAN, wireless mobile radio technology, or Bluetooth.

14. The device as recited in claim 10, wherein the third communications unit is configured for a wired data exchange with an input device which is situated inside the vehicle.

15. The device as recited in claim 10, wherein the device is a discrete component, which is able to be connected to an interface of the vehicle, the interface being an OBD jack.

16. A gateway control unit of a vehicle-internal bus system, the gateway control unit comprising:
a device for filtering safety-relevant interventions, the device including:
a control unit;
a first communications unit which is able to exchange data with at least one bus system of a vehicle;
a second communications unit which is able to exchange data with an external processing unit; and
a third communications unit which differs from the first communications unit and the second communications unit;
wherein the control unit filters data transfer between the first communications unit and the second communications unit as a function of a parameter received by the third communications unit.

17. A method for filtering safety-relevant interventions, between a first communications unit, which is able to exchange data with at least one bus system of a vehicle, and a second communications unit, which is able to exchange data with an external processing, the method comprising:
filtering data transfer between the first communications unit and the second communications unit as a function of a parameter received by the third communications unit, wherein the third communications unit differs from the first communications unit and the second communications unit.

18. The method as recited in claim 17, wherein, as a function of the received parameter, the data transfer is completely interrupted or data are partially filtered.
